(19) United States
(12) Patent Application Publication
(10) Pub. No.: US 2022/0198346 A1
(43) Pub. Date: Jun. 23, 2022

(54) DETERMINING COMPLEMENTARY BUSINESS CYCLES FOR SMALL BUSINESSES

(71) Applicant: Intuit Inc., Mountain View, CA (US)

(72) Inventors: Yair Horesh, Kfar-Saba (IL); Shlomi Medalion, Lod (IL)

(73) Assignee: Intuit Inc., Mountain View, CA (US)

(21) Appl. No.: 17/133,039

(22) Filed: Dec. 23, 2020

(51) Int. Cl. G06Q 10/06; G06N 20/00

(52) U.S. Cl. CPC G06Q 10/067; G06Q 10/0637; G06N 20/00

(57) ABSTRACT

Systems and methods for identifying businesses having complementary business cycles are disclosed. An example method may include receiving financial information for each business of a plurality of businesses, the financial information including a plurality of values of a financial indicator with respect to time, training a machine learning model to determine a preference metric for a pair of businesses based at least in part on respective values of the businesses' financial indicators, for each given business in the plurality of businesses, determining corresponding values of the preference metric, using the training machine learning model, for at least a respective subset of the plurality of businesses, and determining an optimal pairing for each business in the plurality of businesses based at least in part on the determined values of the preference metric.

### TECHNICAL FIELD

This disclosure relates generally to methods for mutual lending among small businesses, and more particularly to the determination of pairs or groups of businesses having complementary business cycles for mutual lending purposes.

### DESCRIPTION OF RELATED ART

Small businesses typically have differing business cycles than one another. More specifically, some businesses may see a substantially larger income or profit in the summer months, as compared to the winter months, while other businesses may see a substantially larger income or profit in the winter months, as compared to the summer months. For example, businesses such as an air conditioning installer or a landscaping supply store typically have higher revenues in the summer months than in the winter months, while businesses such as winter sports retailers typically have higher revenues in the winter months than in the summer months. Additionally, some businesses may have larger incomes at the beginning of each month than at the middle or end of the month, while other businesses may have larger incomes at the middle or end of each month than at the beginning of the month.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods, and devices of this disclosure each have several innovative aspects, no single one of which is solely responsible for the desirable attributes disclosed herein.

One innovative aspect of the subject matter described in this disclosure can be implemented as a method for identifying businesses having complementary business cycles. In some implementations, the method may be performed by a computing system associated with a machine learning model. In some aspects, the method may include receiving financial information for each business of a plurality of businesses, the financial information including a plurality of values of a financial indicator with respect to time. The method may include training a machine learning model to determine a preference metric for a pair of businesses based at least in part on the respective values of the pair of businesses' financial indicators. The method may include determining, for each business of the plurality of businesses, corresponding values of the preference metric using the trained machine learning model for at least a respective subset of the plurality of businesses. The method may include determining an optimal pairing for each business of the plurality of businesses based at least in part on the determined values of the preference metric.

In some implementations, the method may further include identifying one or more businesses of the plurality of businesses having financial indicator values whose cyclicity is less than a value, and filtering the one or more identified businesses from consideration for pairing with other businesses. In some aspects, determining whether or not a business has financial indicator cyclic values less than the value may be based at least in part on a regression tree analysis. In other implementations, the method may further include identifying one or more businesses of the plurality of businesses having financial indicator values whose standard deviation exceeds a threshold value, and filtering the one or more identified businesses from consideration for pairing with other businesses.

In some aspects, the financial indicator includes income. In some aspects, the subset of the plurality of businesses for a respective business includes businesses having an annual income within a threshold amount of the given business. In some aspects, determining the optimal pairing is based at least in part on solving a stable roommates problem for the plurality of businesses and the determined values of the preference metric. In some other aspects, determining the optimal pairing is based at least in part on a greedy look-ahead search algorithm.

In some implementations, the method further includes selecting the subset of the plurality of businesses for the respective business by determining, for each other business of the plurality of businesses, an earth mover's distance between the income of the respective business and the income of the other business, and selecting businesses whose earth mover's distance exceeds a threshold value as the subset. In some aspects, the earth mover's distance is an earth mover's distance between a normalized income distribution of the respective business and a normalized income distribution of the other business.

In some aspects, the method further includes notifying one or more pairs of businesses of the optimal pairing, and offering the one or more notified pairs of businesses a mutual lending agreement. In some aspects, the machine learning model is trained at least in part on training data including historical records of previously accepted mutual lending agreements. In some aspects, the machine learning model is initially trained to determine the preference metric based at least in part on an earth mover's distance between the corresponding financial indicators of a respective pair of businesses.

Another innovative aspect of the subject matter described in this disclosure can be implemented in a system for identifying businesses having complementary business cycles. An example system may include or more processors, and a memory storing instructions for execution by the one or more processors. Execution of the instructions may cause the system to receive financial information for each business of a plurality of businesses, the financial information including a plurality of values of a financial indicator with respect to time. Execution of the instructions may cause the system to train a machine learning model to determine a preference metric for a pair of businesses based at least in part on the respective values of the pair of businesses' financial indicators. Execution of the instructions may cause the system to determine, for each business of the plurality of businesses, corresponding values of the preference metric using the trained machine learning model for at least a respective subset of the plurality of businesses. Execution of the instructions may cause the system to determine an optimal pairing for each business of the plurality of businesses based at least in part on the determined values of the preference metric.

In some implementations, execution of the instructions further causes the system to identify one or more businesses of the plurality of businesses having financial indicator values whose cyclicity is less than a value, and to filter the one or more identified businesses from consideration for pairing with other businesses. In some aspects, determining whether or not a business has financial indicator cyclic values less than the value may be based at least in part on a regression tree analysis. In other implementations, execution of the instructions further causes the system to identify one or more businesses of the plurality of businesses having financial indicator values whose standard deviation exceeds a threshold value, and filter the one or more identified businesses from consideration for pairing with other businesses.

In some aspects, the financial indicator includes income. In some aspects, the subset of the plurality of businesses for a respective business includes businesses having an annual income within a threshold amount of the respective business. In some aspects, determining the optimal pairing is based at least in part on solving a stable roommates problem for the plurality of businesses and the determined values of the preference metric. In some other aspects, determining the optimal pairing is based at least in part on a greedy look-ahead search algorithm.

In some implementations, execution of the instructions further causes the system to select the subset of the plurality of businesses for the respective business by determining, for each other business of the plurality of businesses, an earth mover's distance between the income of the respective business and the income of the other business, and selecting businesses whose earth mover's distance exceeds a threshold value as the subset. In some aspects, the earth mover's distance is an earth mover's distance between a normalized income distribution of the respective business and a normalized income distribution of the other business.

In some aspects, execution of the instructions further causes the system to notify one or more pairs of businesses of the optimal pairing, and to offer the one or more notified pairs of businesses a mutual lending agreement. In some aspects, the machine learning model is trained at least in part on training data including historical records of previously accepted mutual lending agreements. In some aspects, the machine learning model is initially trained to determine the preference metric based at least in part on an earth mover's distance between the corresponding financial indicators of a respective pair of businesses.

Another innovative aspect of the subject matter described in this disclosure can be implemented in a system for identifying businesses having complementary business cycles. An example system may include means for receiving financial information for each business of a plurality of businesses, the financial information including a plurality of values of income with respect to time. The system may include means for training a machine learning model to determine a preference metric for a pair of businesses based at least in part on an earth mover's distance between the corresponding incomes of the pair of businesses. The system may include means for determining, for each given business of the plurality of businesses, corresponding values of the preference metric using the trained machine learning model for at least a respective subset of the plurality of businesses. The system may include means for determining an optimal pairing for each business of the plurality of businesses based at least in part on the determined values of the preference metric.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a business pairing system, according to some implementations.

FIG. 2 shows a high-level overview of an example process flow that may be employed by the business pairing system of FIG. 1.

FIG. 3 shows an illustrative flow chart depicting an example operation for identifying businesses having complementary business cycles, according to some implementations.

FIGS. 4A and 4B show illustrative flow charts depicting example operations for filtering one or more businesses from the plurality of businesses, according to some implementations.

FIG. 5 shows an illustrative flow chart depicting an example operation for selecting subsets of the plurality of businesses, according to some implementations.

FIG. 6 shows an illustrative flow chart depicting an example operation for identifying businesses having complementary business cycles, according to some implementations.

Like numbers reference like elements throughout the drawings and specification.

### DETAILED DESCRIPTION

Implementations of the subject matter described in this disclosure may be used to analyze business data of a plurality of businesses, identify businesses that have sufficiently distinctive business cycles to be paired with one another or other businesses, and optimally pair the identified businesses for mutual lending to each other. For example, businesses may be determined to have a sufficiently distinctive business cycle to be paired with one another or other businesses using a regression tree analysis, for example, by breaking down a business' income histogram into at least two short segments—one having a sufficiently high mean and another having a sufficiently low mean. In some aspects, the mutual lending may have more value to a business depending on how much time elapses between the high mean segment and the low mean segment of the business. Accordingly, an earth mover's distance between two businesses' normalized income histograms may be used as a metric for determining when businesses may be paired with each other for such mutual lending. In some implementations, a variety of factors may also be used to identify businesses suitable for pairing with one another. In some aspects, a machine learning model, such as a classification model, may be trained using a supervisor machine learning framework to determine a score for a given pair of businesses, for example, based on factors such as the earth mover's distance, income, industry, geographical location, and previous successful and failed mutual lending offers. Determining the optimal pairing may be based on the scores determined by the trained machine learning model. In some aspects, determining the optimal pairing may also be based on pairwise efficiency, for example, using an algorithm such as an algorithm for solving a stable roommates problem, a look-ahead greedy search, or other suitable algorithm. Once the optimal pairs of businesses are identified, one or more mutual lending offers may be made to each of the paired businesses. Identifying businesses having appropriately cyclical business cycles and optimally pairing the identified businesses using metrics determined by the trained machine learning model may allow for a more efficient allocation of resources than with conventional solutions. Further, identifying businesses having complementary interests may allow for the provisioning of very low-cost lending, for example, since one business may have surpluses at a time when another business has deficits, and vice versa. These and other aspects of the example implementations are discussed further below.

Various implementations of the subject matter disclosed herein provide one or more technical solutions to the technical problem of identifying businesses among a plurality of businesses which have distinctive business cycles and optimally pairing such businesses with other businesses having complementary business cycles for mutual lending. Using machine learning to determine the pairwise efficiency and determining optimal pairing of the plurality of businesses may be particularly effective for selecting efficient targets for such mutual lending operations, particularly when the plurality of businesses includes a large number of businesses, for example, in the hundreds, thousands, or more. More specifically, various aspects of the present disclosure provide a unique computing solution to a unique computing problem that did not exist prior to electronic or online financial management systems that can maintain and coordinate data from large numbers of businesses in order to optimally pair businesses for mutual lending based on complementary business cycles. As such, implementations of the subject matter disclosed herein are not an abstract idea such as organizing human activity or a mental process that can be performed in the human mind.

Moreover, various aspects of the present disclosure effect an improvement in the technical field of optimally identifying pairs of businesses having complementary business cycles to offer mutual lending between such pairs of businesses. Training the machine learning model and using the trained machine learning model cannot be performed in the human mind, much less using pen and paper. Further, optimally pairing the businesses based on the pairwise efficiency cannot practically be performed in the human mind, as the number of businesses and the number of pairwise efficiencies calculated make such a process highly impractical and time- consuming. In addition, implementations of the subject matter disclosed herein do far more than merely create contractual relationships, hedge risks, mitigate settlement risks, and the like, and therefore cannot be considered a fundamental economic practice.

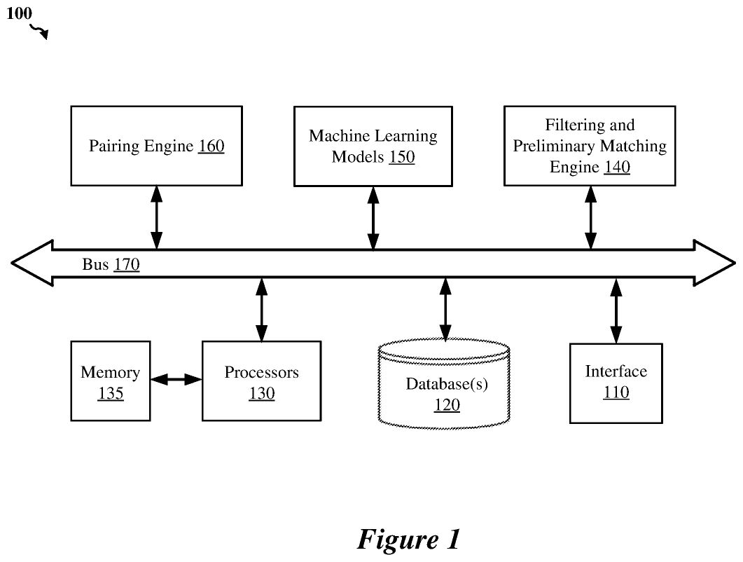

FIG. 1 shows a business pairing system 100, according to some implementations. The business pairing system 100 is shown to include an input/output (I/O) interface 110, a database 120, one or more data processors 130, a memory 135 coupled to the data processors 130, a filtering and preliminary matching engine 140, one or more machine learning models 150, and a pairing engine 160. In some implementations, the various components of the business pairing system 100 may be interconnected by at least a data bus 170, as depicted in the example of FIG. 1. In other implementations, the various components of the business pairing system 100 may be interconnected using other suitable signal routing resources.

The interface 110 may include a screen, an input device, and other suitable elements that allow a user to provide information to the business pairing system 100 and/or to retrieve information from the business pairing system 100. Example information that can be provided to the business pairing system 100 may include configuration information for the business pairing system 100, such as training data for the machine learning models 150, historical business data for each business of the plurality of businesses, business demographic data, such as industry, location, and so on for each business in the plurality of businesses, historical lending data for previous mutual lending agreements for pairs of businesses in the plurality of businesses, one or more rules or algorithms for determining optimal pairing for the pairing engine 160, one or more rules for filtering or preliminary matching for the filtering and preliminary matching engine 140, or the like. Example information that can be retrieved from the business pairing system 100 may include optimal pairings for businesses, one or more pairwise efficiency scores for businesses in the plurality of businesses, one or more recommended mutual lending terms and the like.

The database 120, which may represent any suitable number of databases, may store any suitable information pertaining to business of the plurality of businesses, such as historical financial, demographic, industry, or other information, in addition to training data for the machine learning models 150, configuration information for the business pairing system 100, historical lending data for previous mutual lending agreements for pairs of businesses in the plurality of businesses, one or more rules or algorithms for determining optimal pairing for the pairing engine 160, one or more rules for filtering or preliminary matching for the filtering and preliminary matching engine 140, or the like. For example, the information may include information for each of the businesses analyzed by the business pairing system 100 (such as phone numbers, email addresses, physical mailing address, billing information, and so on), and so on. In some implementations, the database 120 may be a relational database capable of presenting the information as data sets to a user in tabular form and capable of manipulating the data sets using relational operators. In some aspects, the database 120 may use Structured Query Language (SQL) for querying and maintaining the database 120.

The data processors 130, which may be used for general data processing operations (such as manipulating the data sets stored in the database 120), may be one or more suitable processors capable of executing scripts or instructions of one or more software programs stored in the business pairing system 100 (such as within the memory 135). The data processors 130 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the data processors 130 may be implemented as a combination of computing devices (such as a combination of a DSP and a microprocessor, a plurality of microprocessors, one or more microprocessors in conjunction with a DSP core, or any other such configuration).

The memory 135, which may be any suitable persistent memory (such as non- volatile memory or non-transitory memory) may store any number of software programs, executable instructions, machine code, algorithms, and the like that can be executed by the data processors 130 to perform one or more corresponding operations or functions. In some implementations, hardwired circuitry may be used in place of, or in combination with, software instructions to implement aspects of the disclosure. As such, implementations of the subject matter disclosed herein are not limited to any specific combination of hardware circuitry and/or software.

The filtering and preliminary matching engine 140 may analyze information of the businesses and filter one or more of the businesses from consideration for matching by the business pairing system 100. The filtering of businesses may be based on financial information of the businesses, for example, as stored in the database 120. In some aspects, the filtering and preliminary matching engine 140 may filter businesses whose incomes are too variable for consistent pairing with one another. For example, when the standard deviation of a business' weekly, monthly, or annual income exceeds mean income by a certain amount or percentage, the business may not be suitable for pairing. In other aspects, the filtering and preliminary matching engine 140 may filter businesses whose income cyclicity is less than a value (such as not distinctively cyclical). For example, the filtering and preliminary matching engine 140 may determine whether or not a business cycle is distinctively cyclical using one or more suitable techniques, such as one or more regression tree methods that break down an income distribution for a business into at least two short segments, a first segment having a high mean, and a second segment having a low mean. The business cycle may be distinctively cyclical when the first segment is sufficiently large with respect to the second segment (such as greater than the second segment by at least an amount or percentage). Otherwise, the business may be filtered from consideration. Other techniques for determining whether or nor a business cycle is sufficiently cyclical may include one or more chi squared tests, one or more Kolmogorov-Smirnov tests, or other suitable techniques for determining whether or not a business cycle is distinctively cyclical. The filtering and preliminary matching engine 140 may also analyze the financial information for pairs of businesses to determine a subset of potential matches for more detailed analysis by the machine learning models 150. For example, the filtering and preliminary matching engine 140 may analyze many, or all potential pairs of businesses (excluding those filtered out) and determine whether more detailed analysis is warranted. Pairs of businesses may be added to the subset when one or more conditions are satisfied. For example, a pair of businesses may be added to the subset when they have roughly the same income (having an income gap of less than a threshold amount, such as a gap of less than 20%). Another condition may be that the earth mover's distance between the two businesses' normalized income histograms is greater than a threshold. These conditions may ensure that a pair of businesses selected for further consideration are roughly the same size, and that a potential mutual lending operation between the two would be sufficiently likely to be beneficial.

The machine learning models 150 may include any number of machine learning models that can be used to predict pairwise efficiencies for pairs of businesses in the plurality of businesses. A machine learning model can take the form of an extensible data structure that can be used to represent sets of words or phrases and/or can be used to represent sets of attributes or features. The machine learning models may be seeded with historical data indicating relationships between field values and values of dependent fields for one or more historical users. In some implementations, the machine learning models 150 may include deep neural networks (DNNs), which may have any suitable architecture, such as a feedforward architecture or a recurrent architecture. The machine learning models 150 may predict multiple pairwise efficiencies for a given business in the plurality of businesses, for example based on business not filtered, and on preliminary matching performed by the filtering and preliminary matching engine 140. The machine learning models 150 may be trained based on historical financial and demographic data for businesses of the plurality of businesses and on one or more success metrics for previously offered or agreed-upon mutual lending agreements between pairs of businesses in the plurality of businesses, as discussed further below.

The pairing engine 160 may be used to optimally pair businesses based on the pairwise efficiencies determined by the machine learning models 150. Because multiple pairwise efficiencies may be predicted for each business in the plurality of businesses, optimally pairing businesses may include determining a pairing for each of the businesses in a way that optimizes overall efficiency of pairing. As discussed further below, determining such optimal pairing may include suitable algorithms such as a look-ahead greedy search algorithm, or an algorithm for solving a stable roommates problem for the plurality of businesses.

The particular architecture of the business pairing system 100 shown in FIG. 1 is but one example of a variety of different architectures within which aspects of the present disclosure may be implemented. For example, in other implementations, the business pairing system 100 may not include filtering and preliminary matching engine 140, the functions of which may be implemented by the processors 130 executing corresponding instructions or scripts stored in the memory 135. In some other implementations, the functions of the machine learning models 150 may be performed by the processors 130 executing corresponding instructions or scripts stored in the memory 135. Similarly, the functions of the pairing engine 160 may be performed by the processors 130 executing corresponding instructions or scripts stored in the memory 135.

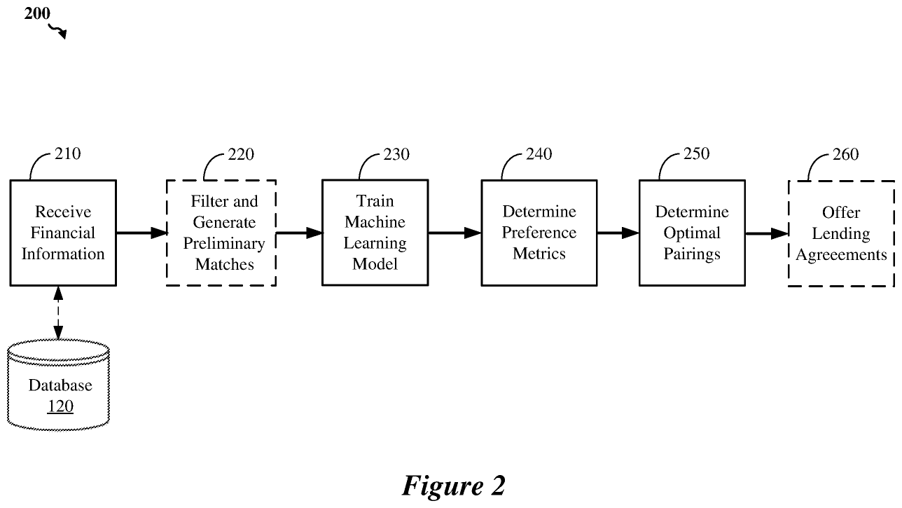

FIG. 2 shows a high-level overview of an example process flow 200 that may be employed by the business pairing system 100 of FIG. 1. In block 210, financial and demographic information is received at the business pairing system 100 for each business of a plurality of businesses. For example, the information may be received via one or more network interfaces coupled to the business pairing system 100, retrieved from the database 120, or retrieved from another memory coupled to the business pairing system 100. In block 220, the request caching engine 150 may filter one or more businesses from the plurality of businesses, and/or generate one or more preliminary matches for businesses in the plurality of businesses.

For example, the filtering and preliminary matching engine 140 may perform such filtering and/or matching in the business pairing system 100. Note that in some aspects the process flow 200 may not include block 220. For such aspects, no businesses may be filtered from further consideration for pairing with one another or other businesses, and no preliminary matches generated. For example, the filtering may be performed before the process flow 200, or not at all. In block 230, the routing engine 140 may train one or more machine learning models to predict pairwise efficiency scores for pairs of businesses of the plurality of businesses. For example, the machine learning models 150 may be trained, based on historical financial and demographic data for businesses of the plurality of businesses and on one or more success metrics for previously offered or agreed-upon mutual lending agreements between pairs of businesses in the plurality of businesses, as discussed further below. In block 240, the one or more trained machine learning models may determine one or more performance metrics for pairs of businesses. For example, the machine learning models 150 may determine one or more performance metrics representing a pairwise efficiency for such pairs of businesses. In some aspects, the one or more performance metrics may be determined for each pair of businesses, while in some other aspects, the performance metrics may be determined for a subset of pairs of businesses, such as pairs of businesses selected as preliminary matches in block 220. In block 250, optimal pairings may be determined based at least in part on the performance metrics determined in block 240. For example, the pairing engine 160 may determine the optimal pairings, based on a suitable algorithm, or set of rules, such as a look-ahead greedy search algorithm, an algorithm for solving a stable roommates problem for the plurality of businesses, or another suitable algorithm. In block 260, one or more mutual lending agreements may be offered to pairs of businesses determined in block 250, as discussed further below.

While not shown in FIG. 2 for simplicity, in some aspects, the process flow 200 may further include receiving one or more success metrics for mutual lending agreements offered to pairs of businesses in block 260. For example, the one or more success metrics may be based at least in part on whether or not a pair of businesses has accepted the mutual lending offer, whether or not the pair of businesses has elected to continue a previously agreed-to mutual lending agreement, whether or not one or more businesses has defaulted or otherwise broken a previously agreed-upon mutual lending agreement, and so on. The business pairing system 100 may then add the one or more success metrics to the training data for the machine learning models 150, for use in subsequent training and performance metric determination operations.

As discussed above, businesses in many industries may have predictable business cycles. For example, some businesses may be seasonally cyclical, earning substantially more income in the summer or winter months, while others may be cyclical on a monthly basis, having predictably high and low income months. Further, some businesses may earn more money towards the beginning of a month than the middle or end of the month, or vice versa. When a pair of businesses have compatible business cycles, this may signal an opportunity for mutual lending between the pair of businesses. For example, a business having income surpluses in the summer, and deficits in the winter, may engage in mutual lending with a business having surpluses in the winter and deficits in the summer. Such lending may be not only beneficial to each business but also a low-cost, for example, as risk and benefit are shared between each business. However, given a large number of businesses, it is a difficult task to not only assess the individual pairwise efficiency of each pair of businesses, but also to identify the optimal parings for each business based on such efficiencies. For example, when considering a plurality of businesses numbering in the hundreds or thousands of businesses, while it may be straightforward to select a few obvious pairs, assessing the individual compatibility of each pair of businesses and optimally pairing off hundreds or thousands of businesses having appropriately complementary business cycles is not practically possible using conventional techniques.

Accordingly, the example implementations may analyze business data of a plurality of businesses, identify businesses that have sufficiently distinctive business cycles to be paired for mutual lending, and optimally pair the identified businesses for mutual lending to each other. More particularly, the example implementations may train one or more machine learning models, such as a classifier, to determine one or more preference metrics for pairs of businesses, where the preference metric indicates a degree of compatibility of the pair of businesses' business cycles. The trained machine learning models may generate preference metrics for pairs of businesses. The example implementations may optimally pair one or more businesses based on the generated preference metrics. The paired businesses may be offered terms for mutual lending agreements with one another based on their determined complementary business cycles.

As noted above in FIG. 1, not every business may be appropriate for pairing. For example, filtering and preliminary matching engine 140 may filter one or more businesses from further consideration for pairing with one another or other businesses based at least in part on one or more financial indicators of the businesses. For example, when receiving the financial information about each of the businesses, one or more statistical operations may be performed. For example, the received financial information may include income on one or more of a daily, monthly, or annual basis. In some aspects, statistical analysis of this financial information may be used to classify businesses as inappropriate for further consideration for pairing with one another or other businesses. For example, a business may be filtered from consideration for pairing when its financial information indicates a certain variability in income. For another example, a business may be filtered from consideration for pairing when its income has a standard deviation that exceeds its mean by a value or percentage. In one example, a standard deviation may be considered excessive relative to its mean when the standard deviation of income is more than 50% of the mean (although other percentages may be used).

Businesses may also be filtered from consideration for pairing when their income is not distinctively cyclical (such as having a cyclicity or periodicity less than a value). Various techniques may be used for determining whether or not a business' income is distinctively cyclical. For example, one or more regression tree techniques may be used to analyze the income data with respect to time, to identify at least two segments, a first segment having a high mean within the income data, and a second segment having a low mean within the income data. A comparison of the first segment and the second segment may be used to determine whether the business' income is distinctively cyclical (and thus whether the business is a suitable candidate for pairing with another business). For example, a difference between a first mean value of the first segment and a second mean value of the second segment may be required to be at least a threshold difference—that is, a business may be filtered from further consideration for pairing if this difference does not meet or exceed the threshold. Similar comparisons may be made using a dividend of the first mean value and the second mean value. Other techniques may also be used for determining whether or not to classify a business as having insufficiently distinctively cyclical income (and thus whether to filter the business from consideration for pairing with another business). For example, a chi-squared test or a Kolmogorov-Smirnov test may also be used to determine whether a business' income is sufficiently distinctively cyclical. Businesses whose income is not sufficiently distinctively cyclical may be filtered from further consideration for pairing with another business.

In addition to filtering businesses as inappropriate for pairing, aspects of the example implementations may limit the number of potential pairs that can be further analyzed. For example, when the plurality of businesses numbers in the thousands, the universe of unique potential pairs may be quite large. Further, while determining the optimal pairings for businesses may be difficult, simpler rule-based techniques may be used to reduce the universe of unique potential pairs to a more manageable size. For example, in some implementations, after filtering businesses from consideration for pairing with one another or other businesses, the filtering and preliminary matching engine 140 may review potential pairs of businesses, and then retain businesses that meet one or more criteria for pairing and/or remove businesses that do not meet those criteria from pairing. In some aspects, a potential pair of businesses may be retained for pairing only if the businesses in the pair have sufficiently similar income, for example, when a difference between the businesses' income is less than a threshold difference. In some aspects, the income distributions of the businesses in a potential pair may be compared using an earth mover's distance in order to determine whether to retain the potential pair of businesses for further analysis. The earth mover's distance is a measure of the “distance” between two distributions over a region and may also be called the Wasserstein metric.

In some implementations, each of a first business' and a second business' income histograms may be interpreted as respective piles of “earth” (the business' income) at a “location” corresponding to the time of such income. For example, a certain amount of income received on a certain day, and another amount on the next, and so on. The earth mover's distance may be the minimum cost of turning the first the first business' “pile” of income into the second business pile of income, where the cost corresponds to the amount of earth moved times the distance by which it is moved. As such, this metric may not only account for differences in income distribution between the two businesses, but also for differences in time between when those incomes were received. For example, moving an amount of income two time units yields twice the cost as moving the same amount of income a single time unit. Potential pairs having comparatively large earth mover's distances are more likely to be good matches for mutual lending. Consequently, the filtering and preliminary matching engine 140 may maintain potential pairs of businesses having an earth mover's distance greater than a threshold. In some aspects, the threshold may be a predetermined threshold. In some other aspects, the threshold may be dynamically defined so as to include a specified portion of the potential matches, for each business (e.g., the threshold may be defined so that for each business, 50% of the potential pairs are maintained).

After identifying and filtering one or more businesses from consideration for pairing with one another or other businesses, the machine learning model (such as machine learning models 150) may determine one or more pairwise efficiency metrics for the potential pairs. In some implementations, the machine learning model may be trained, for example, in a supervised machine learning framework prior to determining the pairwise efficiency metrics. The supervised machine learning framework may represent each pairing of businesses with a record. Each record may include data such as the normalized earth mover's distance between the two businesses' income histograms, and demographic data about the businesses. The demographic data may include the industry to which each business belongs (e.g., a North American Industry Classification System, or NAICS, code), income or other financial data for each of the two businesses, a zip code or zip code prefix for each of the businesses, and other suitable demographic aspects or qualities. The demographic data may also include data features derived from such demographic data, such as a distance between the two businesses (for example based on the zip codes), a common prefix length for the businesses' NAICS codes, and so on. The machine learning framework may be structured to predict a label representing a success metric for mutual lending between the pair of businesses. For example, the success metric may predict whether or not a mutual lending agreement was signed and executed for a specified duration, such as a year, or another suitable metric for measuring successful mutual lending between the two businesses. In other words, the machine learning model may be trained to generate a pairwise efficiency score for an input pair of businesses, based on an associated record, where the score indicates a likelihood for successful mutual lending between the pair of businesses.

The machine learning model, which may be a classification model implemented using a suitable library such as xgBoost, may be trained based on historical records for previously matched pairs of businesses. During initial training of the machine learning model, there may be a cold start problem to resolve because of insufficient historical records of previous mutual lending agreements. In such situations, the machine learning model may be initially trained with a rule-based policy, such as a policy preferring records having maximum normalized earth mover's distance.

The trained machine learning model may generate a pairwise efficiency score for the plurality of businesses. More particularly, for each given business in the plurality of businesses, a pairwise efficiency score may be generated for a number of potential pairs of businesses (including the given business). In some aspects, a pairwise efficiency score may be generated for each potential pair retained by the filtering and preliminary matching engine 140. In other aspects, pairwise efficiency scores may be generated for all pairs of businesses, including the given business. The resulting pairwise efficiency scores may be used to rank the potential pairs for each business.

After the pairwise efficiency scores are generated using the trained machine learning model, the retained businesses may be optimally paired, for example, using the pairing engine 160. Optimally pairing the businesses may involve considering not only the likelihood of success of the pairs of businesses having the highest scores, but also the likelihood of success of all of the businesses. Consequently, optimally pairing the businesses may be performed using suitable techniques including an algorithm for solving a stable roommates problem where each business is a “roommate” and the pairwise efficiency scores represent roommate preferences. Another suitable technique for optimally pairing the businesses is a greedy look-ahead search algorithm. The greedy look-ahead search algorithm may sequentially choose businesses to pair, at each choice “looking ahead” to a number of subsequent potential pairs, and then select the pair of businesses that maximizes the total pairwise efficiency score of the currently selected pair and of subsequent potential pairs. The number of subsequent potential pairs may be any suitable number, such as one, two, three, and so on.

In some implementations, the paired businesses may be notified of their pairing, and may be offered a mutual lending agreement based on the received financial information. For example, the first business of the pair may be asked to agree on a starting and ending date, as well as amounts, for loans to the second business of the pair, and vice versa. Because the loan amounts are likely to be comparable (such as within a value or percentage of one another), these loans may have zero interest rate, or at least substantially lower interest rates than prevailing interest rates.

Information about the acceptance or continuance of the mutual lending agreements may be added to historical data for training the machine learning models. For example, as discussed above, the machine learning model may be trained to predict a label representing a success metric for mutual lending between the pair of businesses (although another metric may be initially substituted for this label). When a pair of businesses agrees to a mutual lending agreement, or when a pair of businesses elects to continue a previously agreed-to mutual lending agreement, this information may be added to the label for the training data for that pair of businesses, thus improving the training data for subsequent operations.

Note that while the above-described implementations treat income as the financial indicator used for filtering, preliminary pairing, determining earth mover's distances, and so on, in some other implementations, the financial indicator may be another suitable metric, such as gross profit, operational net income, and so on. Further, in some aspects businesses may be paired, and lending agreements may be provided with anonymity. That is, privacy for each business may maintain their privacy, and remain unaware of the identity of the other company. Instead, the mutual lending may be provisioned through a third party, such as the party performing the optimal pairing as discussed herein.

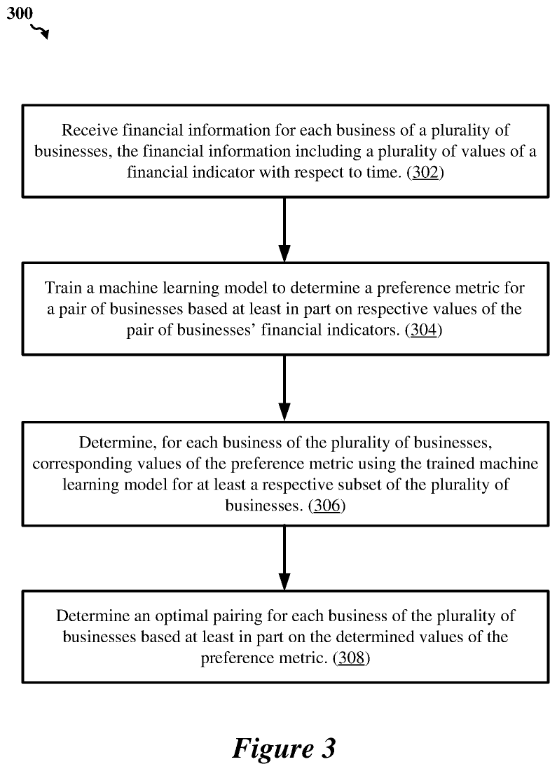

FIG. 3 shows an illustrative flow chart depicting an example operation 300 for identifying businesses having complementary business cycles, according to some implementations. The example operation 300 may be performed by one or more processors of a computing device or system. In some implementations, the example operation 300 may be performed by the business pairing system 100 of FIG. 1. It is to be understood that the example operation 300 may be performed by any suitable systems, computers, or servers. At block 302, the business pairing system 100 receives financial information for each business of a plurality of businesses, where the financial information includes a plurality of values of a financial indicator with respect to time. At block 304, the business pairing system 100 trains a machine learning model to determine a preference metric for a pair of businesses based at least in part on respective values of the pair of businesses' financial indicators. At block 306, the business pairing system 100 determines, for each business of the plurality of businesses, corresponding values of the preference metric using the trained machine learning model for at least a subset of the plurality of businesses. At block 308, the business pairing system 100 determines an optimal pairing for each business of the plurality of businesses based at least in part on the determined values of the preference metric. In various implementations, the machine learning model may be trained based at least in part on training data including historical records of previously accepted mutual lending agreements.

In some aspects, the financial indicator may be income. In some aspects, the subset of the plurality of businesses may include businesses having an annual income within a threshold value of the given business. In some aspects, determining the optimal pairing of businesses may be based at least in part on solving a stable roommates problem for the plurality of businesses and the determined values of the preference metric. In some other aspects, determining the optimal pairing of businesses may be based at least in part on a greedy look- ahead search algorithm. In some aspects, the machine learning model may be initially trained to determine the preference metric based at least in part on an earth mover's distance between the corresponding financial indicators of a respective pair of businesses.

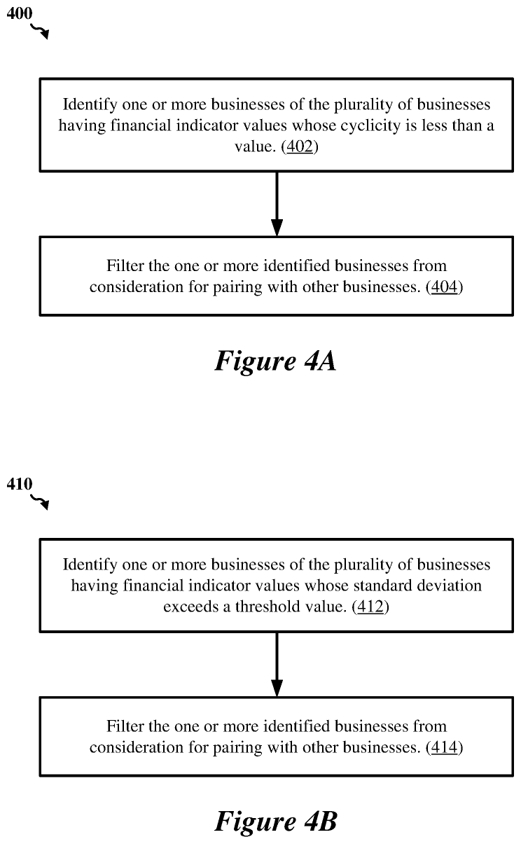

FIG. 4A shows an illustrative flow chart depicting an example operation 400 for filtering one or more businesses from consideration for pairing, according to some implementations. The example operation 400 may be performed by one or more processors of a computing device or system. In some implementations, the example operation 400 may be performed by the business pairing system 100 of FIG. 1. It is to be understood that the example operation 400 may be performed by any suitable systems, computers, or servers. In some implementations, the operation 400 may be performed before determining the corresponding values of the performance metric in block 306 of FIG. 3. For example, at block 402, the business pairing system 100 identifies one or more businesses of the plurality of businesses having financial indicator values whose cyclicity is less than a value. At block 404, the business pairing system 100 filters the one or more identified businesses from consideration for pairing with other businesses. In some aspects, determining that a business has financial indicator cyclic values less than the value may be based at least in part on a regression tree method.

FIG. 4B shows an illustrative flow chart depicting an example operation 410 for filtering one or more businesses from consideration for pairing, according to other implementations. The example operation 410 may be performed by one or more processors of a computing device or system. In some implementations, the example operation 410 may be performed by the business pairing system 100 of FIG. 1. It is to be understood that the example operation 410 may be performed by any suitable systems, computers, or servers. In some implementations, the operation 410 may be performed before determining the corresponding values of the performance metric in block 306 of FIG. 3. For example, at block 412, the business pairing system 100 identifies one or more businesses of the plurality of businesses having financial indicator values whose standard deviation exceeds a threshold value. At block 414, the business pairing system 100 filters the one or more identified businesses from consideration for pairing with other businesses.

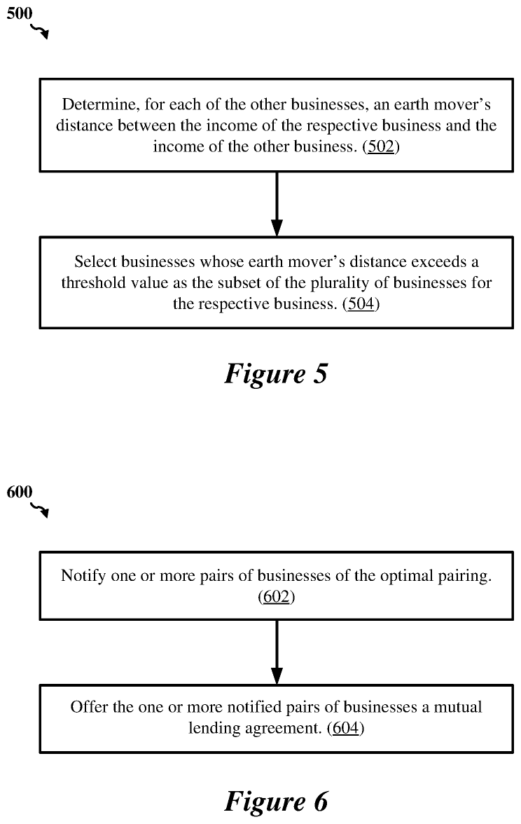

FIG. 5 shows an illustrative flow chart depicting an example operation 500 for selecting subsets of the plurality of businesses, according to some implementations. The example operation 500 may be performed by one or more processors of a computing device or system. In some implementations, the example operation 500 may be performed by the business pairing system 100 of FIG. 1. It is to be understood that the example operation 500 may be performed by any suitable systems, computers, or servers. In some implementations, the operation 500 may be performed in conjunction with one or more of the processes of the example operation 300 of FIG. 3. For example, at block 502, the business pairing system 100 determines, for each of the other business, an earth mover's distance between the income of the respective business and an income of the other business. At block 504, the business pairing system 100 selects the businesses whose earth mover's distance exceeds a threshold value as the subset of the plurality of businesses for the respective business. In some aspects, the earth mover's distance is an earth mover's distance between a normalized income distribution of the given business and a normalized income distribution of the other business.

FIG. 6 shows an illustrative flow chart depicting an example operation 600 for identifying businesses having complementary business cycles, according to some implementations. The example operation 600 may be performed by one or more processors of a computing device or system. In some implementations, the example operation 600 may be performed by the business pairing system 100 of FIG. 1. It is to be understood that the example operation 600 may be performed by any suitable systems, computers, or servers. In some implementations, the operation 600 may be performed after determining the optimal pairing in block 308 of FIG. 3. For example, at block 602, the business pairing system 100 notifies one or more pairs of businesses of the optimal pairing. At block 604, the business pairing system 100 offers the one or more notified pairs of businesses a mutual lending agreement with each other.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

What is claimed is:

1. A method of identifying businesses having complementary business cycles, the method performed by a computing system associated with a machine learning model and comprising:
receiving financial information for each business of a plurality of businesses, the financial information including a plurality of values of a financial indicator with respect to time;
training the machine learning model to determine a preference metric for a pair of businesses based at least in part on the respective values of the pair of businesses' financial indicators;
determining, for each business of the plurality of businesses, corresponding values of the preference metric using the trained machine learning model for at least a respective subset of the plurality of businesses; and
determining an optimal pairing for each business based at least in part on the determined values of the preference metric.

2. The method of claim 1, further comprising, before determining the corresponding values of the preference metric:
identifying one or more businesses of the plurality of businesses having financial indicator values whose cyclicity is less than a value; and
filtering the one or more identified businesses from consideration for pairing with other businesses.

3. The method of claim 2, wherein the one or more businesses are identified using a regression tree method.

4. The method of claim 1, further comprising, before determining the corresponding values of the preference metric:
identifying one or more businesses of the plurality of businesses having financial indicator values whose standard deviation exceeds a threshold value; and filtering the one or more identified businesses from consideration for pairing with other businesses.

5. The method of claim 1, wherein the financial indicator comprises income.

6. The method of claim 5, wherein the subset of the plurality of businesses for a respective business comprises businesses having an annual income within a threshold amount of the respective business.

7. The method of claim 6, further comprising selecting the subset of the plurality of businesses for the respective business by:
determining, for each of the other businesses, an earth mover's distance between the income of the respective business and the income of the other business; and
selecting businesses whose earth mover's distance exceeds a threshold value as the subset of the plurality of businesses for the respective business.

8. The method of claim 7, wherein the earth mover's distance is an earth mover's distance between a normalized income distribution of the respective business and a normalized income distribution of the other business.

9. The method of claim 1, wherein determining the optimal pairing is based at least in part on solving a stable roommates problem for the plurality of businesses and the determined values of the preference metric.

10. The method of claim 1, wherein determining the optimal pairing is based at least in part on a greedy look-ahead search algorithm.

11. The method of claim 1, further comprising:
notifying one or more pairs of businesses of the optimal pairing; and
offering the one or more notified pairs of businesses a mutual lending agreement.

12. The method of claim 11, wherein the machine learning model is trained based at least in part on training data comprising historical records of previously accepted mutual lending agreements.

13. The method of claim 1, wherein the machine learning model is initially trained to determine the preference metric based at least in part on an earth mover's distance between the corresponding financial indicators of a respective pair of businesses.

14. A system for identifying businesses having complementary business cycles, the system associated with a machine learning model, the system comprising:
one or more processors; and
a memory storing instructions that, when executed by the one or more processors, cause the system to:
receive financial information for each business of a plurality of businesses, the financial information including a plurality of values of a financial indicator with respect to time;
train the machine learning model to determine a preference metric for a pair of businesses based at least in part on respective values of the pair of businesses' financial indicators;
determine, for each business of the plurality of businesses, corresponding values of the preference metric using the trained machine learning model for at least a respective subset of the plurality of businesses; and
determine an optimal pairing for each business based at least in part on the determined values of the preference metric.

15. The system of claim 14, wherein the financial indicator comprises income.

16. The system of claim 15, wherein the subset of the plurality of businesses for a respective business comprises businesses having an annual income within a threshold amount of the respective business.

17. The system of claim 16, wherein execution of the instructions causes the system to select the subset of the plurality of businesses for the respective business by:
determining, for each of the other businesses, an earth mover's distance between the income of the respective business and the income of the other business; and
selecting businesses whose earth mover's distance exceeds a threshold value as the subset of the plurality of businesses for the respective business.

18. The system of claim 17, wherein the earth mover's distance is an earth mover's distance between a normalized income distribution of the respective business and a normalized income distribution of the other business.

19. The system of claim 14, wherein the optimal pairing is determined based at least in part on solving a stable roommates problem for the plurality of businesses and the determined values of the preference metric.

20. A system for identifying businesses having complementary business cycles, the system associated with a machine learning model and comprising:
means for receiving financial information for each business of a plurality of businesses, the financial information including a plurality of values of income with respect to time;
means for training the machine learning model to determine a preference metric for a pair of businesses based at least in part on an earth mover's distance between the corresponding incomes of the pair of businesses;
means for determining, for each given business of the plurality of businesses, corresponding values of the preference metric using the trained machine learning model for at least a respective subset of the plurality of businesses; and
means for determining an optimal pairing for each business based at least in part on the determined values of the preference metric.
